(19) United States
(12) Patent Application Publication
(10) Pub. No.: US 2012/0227626 A1
(43) Pub. Date: Sep. 13, 2012

(54) Preparations Of Solid Material

(75) Inventors: Sascha Oestreich, Dusseldorf (DE); Ronald Klagge, Erkrath (DE); Shailesh C. Shah, Dresher, PA (US); Harald Frommelius, Monheim (DE); Thomas Schliwka, Bergisch Gladbach (DE)

(73) Assignee: Cognis IP Management GmbH, Dusseldorf (DE)

(21) Appl. No.: 13/508,601

(22) PCT Filed: Nov. 2, 2010
(86) PCT No.: PCT/EP2010/006669

§ 371 Date: May 8, 2012

Related U.S. Application Data
(60) Provisional application No. 61/259,397, filed on Nov. 9, 2009.

(51) Int. Cl. C09D 5/00

(52) U.S. Cl. 106/287.26

(57) ABSTRACT

Nonionic surfactants selected from the group consisting of (a) the addition products of 1 to 40 mol of alkylene oxide per mol of allyl alcohol wherein the alkylene oxide is selected from the group consisting of ethylene oxide, propylene oxide, butylene oxide and styrene oxide and (b) the addition products of 1 to 40 mol of alkylene oxide per mol of allyl alcohol wherein the alkylene oxide is selected from the group consisting of ethylene oxide, propylene oxide, butylene oxide and styrene oxide, wherein the OH group of these addition products is end group capped in the sense that it is replaced by an OR group, wherein R is an alkyl radical having 1 to 20 carbon atoms, which may be saturated or unsaturated, straight chain or branched, are useful as dispersants in the production of preparations wherein one or more solid materials are dispersed in a liquid medium.

### FIELD OF THE INVENTION

The invention relates to preparations of solid material which comprise (i) a liquid vehicle, (ii) one or more solid materials and (iii) a dispersant, wherein the dispersant comprises a specific nonionic surfactant.

### PRIOR ART

Preparations of solid materials in a liquid vehicle are very important in various technical fields. They are used, for example, in the manufacture and processing of paints, printing inks, paper coatings, leather and textile colors, pastes, pigment concentrates, ceramics and cosmetic preparations. Similarly, preparations of solid materials, for example pigments and/or fillers, are used in the manufacture or processing of casting and molding compositions based on synthetic, semisynthetic or natural polymers. Preparations of solid materials are also used, for example, in the manufacture of casting compositions, PVC plastisols, gel-coats, polymer concrete, circuit boards, industrial coatings, wood and furniture coatings, automotive coatings, marine paints, corrosion control paints, can and coil coatings, decorating paints and architectural coatings, in which case the solid materials are admixed with customary known binders and/or solvents, pigments and optionally fillers, dispersing assistants and further customary auxiliary materials.

In this connection, surfactants are frequently used as dispersing agents. These surfactants are generally nonionic or anionic in nature. A large number of different dispersing agents of the surfactant type have been described in the literature. Being surface-active agents, the dispersing agents are effective in wetting the particles of solid material which are to be dispersed, and facilitate the disintegration of agglomerates. The dispersing agents also have a stabilizing effect on the dispersions obtained, and inhibit any reagglomeration or flocculation of the particles of solid material. Dispersants are particularly important, for example, for dispersing pigments and fillers in the manufacture of printing inks, paints and coatings.

However, when surfactants are used as dispersing assistants, the dispersing operation is frequently observed to give rise to undesirable foaming. This foaming is generally sought to be suppressed by the additional use of strong defoamers (millbase defoamers for example). Regrettably, these strong defoamers can lead to undesirable effects in the processing chain (cratering, pin holes, etc.).

Pigment concentrates are produced by using shearing machines to disperse pigments in a liquid vehicle sufficiently finely for the pigment to be permanently present in the form of primary particles. Suitable shearing machines will be known to a person skilled in the art.

Owing to the importance of dispersion for the coatings, paints and printing ink industry, not only the process of dispersing but also the low molecular weight and high molecular weight compounds suitable for stabilizing the primary particles are extensively described in the technical literature. The known prior art does not teach how to specifically select additives which provide efficacious support for the formulation of pigment concentrates, specifically when these pigment concentrates are to permit the manufacture of low-emission or even no-emission paints and printing inks, or when they are to be free of substances not generally recognized as safe by ecologists or ecotoxicologists.

A particular difficulty is the formulation of aqueous pigment concentrates, particularly when this is to be done without addition of low molecular weight cosolvents such as ethylene glycol or propylene glycol. True, as a person skilled in the art will know, pigmentary dispersants based on polyphosphates or polyacrylates are very useful for keeping pigments and fillers in suspension in emulsion paints alongside the latex particles stabilized by other dispersants or protective colloids, but are not useful for preparing pigment concentrates having the above-described performance profile.

Most dispersing agents that are useful in organic base oils of varying polarity fail when water is used as continuous phase for the pigment concentrates. On the other hand, surfactant-type dispersing agents that have good pigment-wetting properties, such as alkylphenol polyglycol ethers, have recently become ecologically controversial with regard to their biodegradability, not only in the laundry detergent and cleaner industry, where in Germany they have already been completely replaced as surfactants, but also in emulsion polymerization, i.e., in the production of aqueous binders for emulsion paints.

A further complicating factor with regard to the choice of additives for the formulation of pigment concentrates is that the dispersing additive has to be chosen such that the viscosity of the continuous phase shall decrease with increasing shearing force, i.e., shall be pseudoplastic and must in no way be dilatant, substantially independently of the base oil.

Another factor to be taken into account when formulating pigment concentrates is that a specifically calibrated balance has to be struck between water-retention capacity and hygroscopicity such that the self-drying tendency of the concentrate is substantially retarded. Incipiently dried pigment concentrates shall be easy to redisperse. On the other hand, water-retention capacity and hygroscopicity must not become so high that the final applied coat becomes water-sensitive.

Also other performance characteristics of the final paint such as freeze-thaw stability, storage stability, shear stability may be as little adversely affected as the properties of the cured film, examples being clarity, gloss or resistance to whitening.

A further requirement to be met by the pigment concentrates to be developed according to the present invention is that they shall be compatible with a broad spectrum of binders and base varnishes, but at the same time also with water as well as with different solvents used in paints, and also with the highly alkaline water glasses used in silicate paints.

Surfactants are frequently used to produce aqueous formulations of solid material, such as pigment pastes or pigment concentrates for example. These surfactants are generally nonionic or anionic in nature. A large number of different surfactant-type dispersing agents have been described in the literature.

A frequent problem in connection with the use of surfactant-type dispersing assistants is the appearance of foam during the dispersing operation. Attempts have been made to inhibit the appearance of foam through the use of strong defoamers. Often, the use of these so-called millbase defoamers is associated with further problems in the processing chain. It is therefore desirable to provide surfactant-type dispersing assistants which exhibit a minimal tendency to foam and yet make it possible to formulate stable preparations of solid material.

### SUMMARY OF THE INVENTION

The present invention has for its object to provide efficacious additives for producing preparations wherein one or more solid materials are dispersed in a liquid medium, in particular aqueous pigment concentrates, and also the thereby obtainable pigment concentrates themselves, that meet the multiplicity of the abovementioned criteria with respect to the desirable performance profile of such additions or of the pigment concentrates themselves.

More particularly, it is an object of the present invention with regard to the above-described problems relating to the production of preparations of solid material, in particular aqueous pigment concentrates, to provide surfactant-type dispersants which exhibit a minimal tendency to foam and make possible the formulation of stable preparations of solid material. More particularly, these dispersants should have a positive effect on the viscosity of the preparations of solid material which are produced. Furthermore, the pigment concentrates produced using these dispersants shall be notable for enhanced color intensity when used for tinting white color, be highly compatible with the base color and not flocculate.

The present invention provides for the use of nonionic surfactants selected from the group consisting of
(a) the addition products of 1 to 40 mol of alkylene oxide per mol of allyl alcohol wherein the alkylene oxide is selected from the group consisting of ethylene oxide, propylene oxide, butylene oxide and styrene oxide and
(b) the addition products of 1 to 40 mol of alkylene oxide per mol of allyl alcohol wherein the alkylene oxide is selected from the group consisting of ethylene oxide, propylene oxide, butylene oxide and styrene oxide, wherein the OH group of these addition products is end group capped in the sense that it is replaced by an OR group, wherein R is an alkyl radical having 1 to 20 carbon atoms, which may be saturated or unsaturated, straight chain or branched,
   as dispersants in the production of preparations wherein one or more solid materials are dispersed in a liquid medium.

In a preferred embodiment, the present invention relates to the use of the dispersants (a) and/or (b) as additives for producing aqueous pigment concentrates.

The amount of dispersants (a) and/or (b) used according to the present invention depends on the nature of the dyes to be dispersed and also on the amount of the dyes to be dispersed. Preferably, the compounds (a) and/or (b) are used in an amount of 0.1% to 20% by weight based on the entire pigment concentrate.

The dispersants to be used according to the present invention are very particularly noticeable for reducing foaming during the dispersing operation and positively influencing the viscosity of the preparations of solid material which are produced. Furthermore, the aqueous pigment concentrates thus produced are notable for leading to increased color intensity in use.

The present invention further provides preparations of a solid material, comprising

(i) a liquid vehicle,
(ii) one or more solid materials and
(iii) a dispersant
with the proviso that the dispersant used is a nonionic surfactant selected from the group consisting of
(a) the addition products of 1 to 40 mol of alkylene oxide per mol of allyl alcohol wherein the alkylene oxide is selected from the group consisting of ethylene oxide, propylene oxide, butylene oxide and styrene oxide and
(b) the addition products of 1 to 40 mol of alkylene oxide per mol of allyl alcohol wherein the alkylene oxide is selected from the group consisting of ethylene oxide, propylene oxide, butylene oxide and styrene oxide, wherein the OH group of these addition products is end group capped in the sense that it is replaced by an OR group, wherein R is an alkyl radical having 1 to 20 carbon atoms, which may be saturated or unsaturated, straight chain or branched.

In one embodiment, the preparations of solid material comprise
15% to 85% by weight of a liquid vehicle (i),
10% to 80% by weight of one or more solids (ii) and
0.1% to 20% by weight of a dispersant (iii) from the group of compounds (a) and (b).

In a preferred embodiment, the compounds (II) comprise pigments. With regard to the choice of pigments (ii), there are no limitations whatsoever in the realm of the present invention. As a person skilled in the art will know, pigments comprise particulate organic or inorganic materials which can be either themselves color-conferring or delustering and which are virtually insoluble in solvents or binders. Many inorganic pigments also act as fillers, and vice versa. Examples of particularly common classes of pigments can be discerned from the relevant technical literature.

Liquid vehicle media (i)—organic base oils or water for example—will be known to a person skilled in the art. In a preferred embodiment, water is chosen as liquid vehicle (i) and the solids (ii) are pigments. In this case, the preparations of solid material are thus aqueous pigment concentrates.

The present invention further provides a process for producing aqueous preparations of solid material which are pumpable and flowable at 25° C., in particular aqueous pigment concentrates, which comprises a nonionic surfactant selected from the group consisting of
(a) the addition products of 1 to 40 mol of alkylene oxide per mol of allyl alcohol wherein the alkylene oxide is selected from the group consisting of ethylene oxide, propylene oxide, butylene oxide and styrene oxide and
(b) the addition products of 1 to 40 mol of alkylene oxide per mol of allyl alcohol wherein the alkylene oxide is selected from the group consisting of ethylene oxide, propylene oxide, butylene oxide and styrene oxide, wherein the OH group of these addition products is end group capped in the sense that it is replaced by an OR group, wherein R is an alkyl radical having 1 to 20 carbon atoms, which may be saturated or unsaturated, straight chain or branched,
   being mixed with water, metering the solid material to the resulting mixture and dispersing the latter.

By “pumpable and flowable at 25° C.” is meant that the viscosity of the preparations of solid material is below 20 000 mPas, preferably below 5000 mPas (cone-plate 1° cone, d=40 mm; shear rate stipulated: 10 s⁻¹, from Malvern Instruments) at 25° C.

When the solid material is dispersed, there are no particular restrictions here with regard to the way of technically accomplishing the dispersing. A person skilled in the art will accordingly be able to resort to any dispersing technique known to him or her in the field. More particularly, he or she will be able to resort to methods wherein shearing and/or grinding forces act intensively on the system.

The desired fine adjustment of fineness and consistency of the dispersion can be influenced via various techniques in the process of the present invention, for example via the nature of the stirrer or mixing assembly and further by the amount of dispersant (a) and/or (b) added.

A further process for producing the preparation of solid material that is in accordance with the present invention comprises initially forming a dry mixture of a pigment with the dispersants (a) and (b) to form a pulverulent preparation of solid material. This pulverulent preparation of solid material can be dispersed in water in a second step to obtain the aqueous preparation of solid material that is in accordance with the present invention.

Solid materials for the purposes of this invention can be inorganic or organic solid materials. Preferred solid materials are pigments, for example titanium dioxide, carbon black, iron oxides, organic pigments, phthalo, etc.

The aqueous preparations of solid material which are in accordance with the present invention can be produced using, if desired, additional further dispersing assistants other than the compounds (a) and (b), examples being polyacrylate, polyurethane or polyether derivatives.

The dispersants of the present invention can be used not only alone but also combined with other nonionic, anionic or cationic dispersants. Preference is given here to addition products of 1 to 50 mol of ethylene oxide or propylene oxide onto fatty alcohols.

The preparations of solid material which are prepared using the dispersing agents of the present invention can be used in a multiplicity of applications. Examples which may be mentioned here are paints, coatings, printing inks, textile colors, paper coatings, ceramics and casting and molding compositions. The applications in question can be aqueous and/or solvent-containing in nature.

The preparations of solid material which are in accordance with the present invention and, more particularly, are aqueous can be prepared using, if desired, further auxiliaries, such as defoamers, preservatives, wetting agents, deaerators or prior art anti-settling agents, waxes or rheology additives.

### Concerning Compounds (a)

Compounds (a) comprise addition products of 1 to 40 mol of alkylene oxide per mol of allyl alcohol wherein the alkylene oxide is selected from the group consisting of ethylene oxide, propylene oxide, butylene oxide and styrene oxide.

### Concerning Compounds (b)

Compounds (b) comprise addition products of 1 to 40 mol of alkylene oxide per mol of allyl alcohol wherein the alkylene oxide is selected from the group consisting of ethylene oxide, propylene oxide, butylene oxide and styrene oxide, wherein the OH group of these addition products is end group capped in the sense that it is replaced by an OR group, wherein R is an alkyl radical having 1 to 20 carbon atoms which may be saturated or unsaturated, straight chain or branched.

### Alkylene Oxide Units

Compounds (a) and (b) to be used according to the present invention contain alkylene oxide (AO) units as structural elements, namely ethylene oxide (EO), propylene oxide (PO), butylene oxide (BuO) and styrene oxide (StO).

It may be noted that each of the AO structural elements may not only be constructed exclusively of EO, or exclusively of PO, or exclusively of BuO or exclusively of StO units, but also may contain EO, PO, BuO and StO units in mixed form, blockwise or random distribution.

Such compounds (a) and (b) as contain EO and/or PO units as AO structural elements are preferred in the realm of the present invention.

The compounds from the group consisting of (a) and (b) which are to be used according to the present invention can be used as sole dispersants (primary dispersants) in the production of preparations of solid material such as aqueous pigment concentrates for example. However, it is also possible to use them together with one or more anionic dispersants, cationic dispersants or nonionic dispersants (other than the compounds (a) and (b)).

The dispersants of group, (a) and (b) which are used according to the present invention are used in an amount of 0.1% to 20% by weight, preferably 0.5% to 10% by weight and particularly 1% to 5% by weight—the weight percentages each being based on the total amount of preparations of solid material.

In a further embodiment, the preparations of solid material which are in accordance with the present invention—pigment concentrates in particular—in addition to the obligatory constituents a), b) and c) additionally include 0.1% to 30% by weight of one or more co-additives from the group of polyethylene glycols and polyglycol ethers (obtainable by ethoxylation of 1, 2 or 1,3-propanediol, 1,2 or 1,4-butanediol, hexanediol, glycerol, trimethylol-propane or pentaerythritol), these compounds having a molecular weight in the range from 200 to 1000, preferably 200 to 600.

The preparations of solid material which are in accordance with the present invention—pigment concentrates in particular—may in addition to the obligatory constituents a), b) and c) mentioned additionally include further ingredients customary in pigment concentrates. Examples thereof are defoamers, preservatives, dryness retarders and anti-settling agents.

The pigment concentrates of the present invention are useful for coloring paints, for example by the do-it-yourself home improver or by the skilled artisan in paint banks or else at the premises of the paint's manufacturer. However, the pigment concentrates of the present invention can likewise be used for coloring other paints or coatings, such as printing inks, leather dressings, wallpaper colors, wood varnishes, wood preservative systems and wood stains, overprint varnishes, or air-drying or oven-drying industrial coatings, and also for pigmenting colored pencil leads, fiber tip pens, inkjet inks, graphics inks, pastes for ballpoint pens, shoe polishes, nonwoven webs, colored paper coating slips and paper pulp colorings, printing inks for cardboard, spin-dyeing colorants and self-supporting films/sheets.

### EXAMPLES

### Substances Used

FA-10EO:

Addition product of 10 mol of ethylene oxide onto a fatty alcohol (Disponil LS 30, from Cognis)

Breox I:

Ethylene oxide addition product onto allyl alcohol (Breox AA E 450 H from Cognis)

DM-V:

“Hydropalat 1080” from Cognis (commercially available dispersing agent mixture for comparison)

Dehydran 1650:

Commercially available defoamer (from Cognis)

AMP:

2-amino-2-methyl-1-propanol (from Angus); used for setting the pH

DM-E (Dispersing Agent Mixture According to the Invention):

Was prepared by mixing 455 g of FA-10EO and 195 g of Breox I plus addition of water (active substance content of mixture=80% by weight).

### Performance Tests

The numbers reported in tables a) and b) are parts by weight.

### a) Inventive Preparations of Solid Material:

| | V2 | V4 | V6 | V8 | V10 |
|---|---|---|---|---|---|
| Completely ion- | 49.00 | 54.00 | 46.50 | 58.40 | 50.85 |
| free water | | | | | |
| DM-V | | | | | |
| DM-E | 15.00 | 15.00 | 12.50 | 15.60 | 13.10 |
| Dehydran 1650 | 1.00 | 1.00 | 1.00 | 1.00 | 1.00 |
| AMP | 0.05 | | | | |
| Novoperm Red F3 | 35.00 | | | | |
| RK70 | | | | | |
| Hostaperm Pink E | | 30.00 | | | |
| Hansa Brilliant | | | 40.00 | | |
| Yellow 2GX70 | | | | | |
| Special Black 100 | | | | 25.00 | |
| Heliogen Blue L | | | | | 35.00 |
| 7080 | | | | | |
| Total: | 100.00 | 100.00 | 100.00 | 100.00 | 100.00 |

The components were initially dispersed in the so-called premix and then for 60 min in a Skandex mixer with 3 mm beads (1:1).

### b) Noninventive Preparations of Solid Material:

| | V1 | V3 | V5 | V7 | V9 |
|---|---|---|---|---|---|
| Completely ion- | 49.00 | 54.00 | 46.50 | 58.40 | 50.85 |
| free water | | | | | |
| DM-V | 15.00 | 15.00 | 12.50 | 15.60 | 13.10 |
| DM-E | | | | | |
| Dehydran 1650 | 1.00 | 1.00 | 1.00 | 1.00 | 1.00 |
| AMP | | | | | 0.05 |
| Novoperm Red F3 | 35.00 | | | | |
| RK70 | | | | | |
| Hostaperm Pink E | | 30.00 | | | |
| Hansa Brilliant | | | 40.00 | | |
| Yellow 2GX70 | | | | | |
| Special Black 100 | | | | 25.00 | |
| Heliogen Blue L | | | | | 35.00 |
| 7080 | | | | | |
| Total: | 100.00 | 100.00 | 100.00 | 100.00 | 100.00 |

The components were initially dispersed in the so-called premix and then for 60 min in a Skandex mixer with 3 mm beads (1:1).

### Test Results

### Foam Behavior:

Foam behavior was assessed by visual inspection after the dispersing operation (5=very good; 1=very bad):

### c) Inventive Preparations of Solid Material

| | V2 | V4 | V6 | V8 | V10 |
|---|---|---|---|---|---|
| Foam | 5 | 5 | 3 | 5 | 3 |
| behavior | | | | | |

### d) Noninventive Preparations of Solid Material

| | V1 | V3 | V5 | V7 | V9 |
|---|---|---|---|---|---|
| Foam | 4 | 5 | thickened | 5 | 2 |
| behavior | | | | | |

### Viscosities:

Viscosities were measured in a CVO 100 rotary viscometer from Bohlin at 25° C. (cone-plate 1° cone, d=40 mm; shear rate stipulated: 1-1000 s⁻¹, from Malvern Instruments) after 1 day's storage at room temperature, after 2 weeks' storage at 40° C. and after 4 weeks' storage at 40° C. The viscosities reported in tables e) and f) are in mPas.

### e) Viscosities of Inventive Preparations of Solid Material:

| 1 | V2 | V4 | V6 | V8 | V10 |
|---|---|---|---|---|---|
| Viscosity after | | | | | |
| 1 day 25° C. | | | | | |
| 1 | 4.400 | 26.000 | 6295 | 55 | 1150 |
| 10 | 2.700 | 5.000 | 1980 | 39 | 245 |
| 100 | 700* | 1.000 | 2550 | 28 | 80 |
| 1000 s⁻¹ | 1100* | 300 | 590 | 25 | 35 |
| Viscosity after | | | | | |
| 2 weeks 40° C. | | | | | |
| 1 | — | — | 32000 | 54 | — |
| 10 | — | — | 10000 | 34 | — |
| 100 | — | — | 3500 | 28 | — |
| 1000 s⁻¹ | — | — | 700 | 26 | — |
| Viscosity after | | | | | |
| 4 weeks 40° C. | | | | | |
| 1 | 75000 | 67000 | 145500 | 70 | 1500 |
| 10 | 25000 | 11500 | 22000 | 45 | 280 |
| 100 | 7200 | 2400 | 5500 | 35 | 75 |
| 1000 s⁻¹ | 1900 | 550 | 800 | 25 | 35 |

### f) Viscosities of Noninventive Preparations of Solid Material:

| 1 | V1 | V3 | V5 | V7 | V9 |
|---|---|---|---|---|---|
| Viscosity after | | | | | |
| 1 day 25° C. | | | | | |
| 1 | 3.800 | 35.500 | 415000 | 49 | 5400 |
| 10 | 1.500 | 8.000 | 49000 | 35 | 900 |
| 100 | 850* | 1.900 | 10000 | 30 | 170 |
| 1000 s⁻¹ | 1500* | 600 | 1000 | 29 | 45 |
| Viscosity after | | | | | |
| 2 weeks 40° C. | | | | | |
| 1 | — | — | thickened | 50 | — |
| 10 | — | — | thickened | 34 | — |
| 100 | — | — | thickened | 30 | — |
| 1000 s⁻¹ | — | — | thickened | 27 | — |
| Viscosity after | | | | | |
| 4 weeks 40° C. | | | | | |
| | 14000 | 57000 | — | 80 | 5500 |
| 10 | 10500 | 13800 | — | 55 | 950 |
| 100 | 8500 | 3700 | — | 45 | 180 |
| 1000 s⁻¹ | 1800 | 1080 | — | 35 | 60 |

### Gloss, Color Strength and Rub-Out:

The preparations of solid material were let down with a decorating paint of the following recipe (data in parts by weight:

### Decorating Paint, White, High Gloss

| 1. | 1,2-propylene glycol | 2.10 | |
|---|---|---|---|
| 2. | ethyl diglycol | 3.70 | |
| add with stirring: | | | |
| 3. | AMP | 0.23 | (1) |
| 4. | Dehydran 1293 | 0.30 | (x) |
| 5. | completely ion-free water | 8.00 | |
| 6. | Hydropalat 3275 | 1.20 | (x) |
| 7. | Tioxide R-HD-2 | 23.00 | (2) |
| dispersing, particle fineness: <10 μm | | | |
| (dissolver, no beads, about 30 min) | | | |
| 8. | DSX 1514 | 0.70 | (x) |
| 9. | NeoCryl XK-90 | 56.00 | (3) |
| 10. | Dehydran 1293 | 0.70 | (x) |
| 11. | completely ion-free water | 4.07 | |
| | | 100.00 | |

Key:
(x) Cognis GmbH, Düsseldorf;
(1) Angus Chemie GmbH, Essen;
(2) Tioxide Europe GmbH, Ratingen;
(3) NeoResins, AC Waalwijk (NL)

For letdown, 95 g of decorating paint (white) were mixed with 5 g of the preparations of solid material. Subsequently, the paint obtained was applied with a film-drawing bar (150 μm, wet).

| | | | | | | | | | |
|---|---|---|---|---|---|---|---|---|---|
| V1 | V2 | V3 | V4 | V5 | V6 | V7 | V8 | V9 | V10 |

5% paste on decorating paint white, XK 90 base, aqueous

| | | | | | | | | | | |
|---|---|---|---|---|---|---|---|---|---|---|
| Gloss 60% | 74 | 75 | 78 | 79 | — | — | 76 | 75 | 68 | 72 |
| Color strength chromatic | Ref. | 100 | Ref. | 97 | — | — | Ref. | 100 | Ref. | 103 |
| Rub-out | 1.25/ | 1.11/ | 1.58/ | 1.20/ | — | — | 1.02/ | 0.83/ | 1.74/ | 1.54/ |
| | 1.54 | 1.51 | 1.93 | 1.44 | | | 1.10 | 0.92 | 1.96 | 1.68 |

Gloss was measured using a micro-tri-gloss from Byk-Gardner Instruments.

Colorimetry was measured with an X-rite SP64 spectrophotometer (measuring geometry d/8°) from X-rite.

Rub-out was determined by rubbing the lower third of the paint film 5 min after application until it was almost dry, or the viscosity was such that the pigments stopped separating. After drying was complete, delta E (overall color difference) and delta L (lightness difference) between rubbed area and unrubbed area were measured.

It emerged that the inventive preparations of solid material exhibit less foaming and lower viscosities. Gloss and color strength development were not adversely affected. The inventive preparations of solid material further exhibited reduced rub-out.

1. A method of producing a preparation, the method comprising:
dispersing one or more solid materials in a liquid medium using a nonionic surfactant dispersant selected from the group consisting of (a) the addition products of 1 to 40 mol of alkylene oxide per mol of allyl alcohol wherein the alkylene oxide is selected from the group consisting of ethylene oxide, propylene oxide, butylene oxide and styrene oxide and (b) the addition products of 1 to 40 mol of alkylene oxide per mol of allyl alcohol wherein the alkylene oxide is selected from the group consisting of ethylene oxide, propylene oxide, butylene oxide and styrene oxide, wherein the OH group of these addition products is end group capped in the sense that it is replaced by an OR group, wherein R is an alkyl radical having 1 to 20 carbon atoms, which may be saturated or unsaturated, straight chain or branched.

2. The method of claim 1, wherein the liquid medium is water.

3. The method of claim 2, wherein pigments are used as solid material.

4. A preparation of a solid material, comprising (i) a liquid vehicle, (ii) one or more solid materials and (iii) a dispersant with the proviso that the dispersant used is a nonionic surfactant selected from the group consisting of (a) the addition products of 1 to 40 mol of alkylene oxide per mol of allyl alcohol wherein the alkylene oxide is selected from the group consisting of ethylene oxide, propylene oxide, butylene oxide and styrene oxide and (b) the addition products of 1 to 40 mol of alkylene oxide per mol of allyl alcohol wherein the alkylene oxide is selected from the group consisting of ethylene oxide, propylene oxide, butylene oxide and styrene oxide, wherein the OH group of these addition products is end group capped in the sense that it is replaced by an OR group, wherein R is an alkyl radical having 1 to 20 carbon atoms, which may be saturated or unsaturated, straight chain or branched.

5. The preparation according to claim 4, wherein the liquid medium is water.

6. The preparation according to claim 5, wherein the solid material comprises one or more pigments.

7. The preparation according to any one of claim 4, further comprising one or more dispersants other than the compounds (a) and (b).

8. A process for producing aqueous preparations of solid material which are pumpable and flowable at 25° C., the process comprising
mixing water with a nonionic surfactant selected from the group consisting of (a) the addition products of 1 to 40 mol of alkylene oxide per mol of allyl alcohol wherein the alkylene oxide is selected from the group consisting of ethylene oxide, propylene oxide, butylene oxide and styrene oxide and (b) the addition products of 1 to 40 mol of alkylene oxide per mol of allyl alcohol wherein the alkylene oxide is selected from the group consisting of ethylene oxide, propylene oxide, butylene oxide and styrene oxide, wherein the OH group of these addition products is end group capped in the sense that it is replaced by an OR group, wherein R is an alkyl radical having 1 to 20 carbon atoms, which may be saturated or unsaturated, straight chain or branched;
metering a solid material to the resulting mixture; and
dispersing the latter.

9. The process according to claim 8, wherein the liquid medium is water.

10. The process according to claim 9, wherein the solid material comprises one or more pigments.

11. The process according to claim 8, further comprising using one or more dispersants other than the compounds (a) and (b).

12. The process according to claim 5, further comprising one or more dispersants other than the compounds (a) and (b).

13. The process according to claim 6, further comprising one or more dispersants other than the compounds (a) and (b).
